(19) United States
(12) Patent Application Publication
(10) Pub. No.: US 2025/0260041 A1
(43) Pub. Date: Aug. 14, 2025

(54) APPARATUS AND CORRESPONDING METHOD FOR PRODUCING AN ELECTRODE STACK FROM ELECTRODE STACK ELEMENTS

(71) Applicants: Volkswagen Aktiengesellschaft, Wolfsburg (DE); Giesecke+Devrient Currency Technology GmbH, Muenchen (DE)

(72) Inventors: Dennis BOEHM, Wolfenbuettel (DE); Alexander BREUER, Celle (DE); Marco JORDAN, Salzgitter (DE); Frank NEUDEL, Freising (DE); Xaver THUM, Wolfratshausen (DE)

(73) Assignees: Volkswagen Aktiengesellschaft, Wolfsburg (DE); Giesecke+Devrient Currency Technology GmbH, Muenchen (DE)

(21) Appl. No.: 19/190,206

(22) Filed: Apr. 25, 2025

Related U.S. Application Data
(63) Continuation of application No. PCT/EP2023/079304, filed on Oct. 20, 2023.

(30) Foreign Application Priority Data
Oct. 25, 2022 (DE) 10 2022 211 304.7
Nov. 11, 2022 (DE) 10 2022 211 988.6

(51) Int. Cl. H01M 10/04; H01M 10/0585

(52) U.S. Cl. CPC H01M 10/0404; H01M 10/0585

(57) ABSTRACT

An apparatus for producing an electrode stack from electrode stack elements is provided. A stacking wheel has at least one stacking wheel disc, which can be rotationally driven about an axis of rotation and which has compartments for receiving the electrode stack elements. A stripper strips the electrode stack elements from the compartments during a rotation of the stacking wheel. A shelf is provided for the electrode stack elements stripped from the stacking wheel. A conveyor conveys the electrode stack elements into the compartments. The conveyor comprises a transfer device for transferring the electrode stack elements into the compartments and a feeding device for feeding the electrode stack elements to the transfer device. A method for producing an electrode stack using the apparatus is also provided.

This nonprovisional application is a Continuation of International Application PCT/EP2023/079304 filed on Oct. 20, 2023, which claims priority to German Patent Application No. 10 2022 211 304.7, which was filed in Germany on Oct. 25, 2022 and German Patent Application No. 10 2022 211 988.6, which was filed in Germany on Nov. 11, 2022 and which are all herein incorporated by reference.

### BACKGROUND OF THE INVENTION

### Field of the Invention

The invention relates to an apparatus and to a method for producing an electrode stack using a stacking wheel.

### Description of the Background Art

A lithium-ion battery has at least one battery cell in which an electrode stack with a number of sheet-like cathodes (cathode sheets, cathode films) and sheet-like anodes (anode sheets, anode films) is accommodated, the cathodes and anodes being stacked on top of one another, for example, and in each case a separator being arranged between the cathodes and anodes.

The electrode stack with anodes and cathodes stacked on top of one another is produced, for example, via so-called single-sheet stacking. Typically, the individual anodes and cathodes are moved via a gripper system (gripping system). A gripper of this gripper system picks up the respective electrode, therefore, the respective anode or cathode, conveys it while holding it to a stacking location and deposits the electrode there. However, such gripper systems are comparatively slow. As a result, the manufacturing process of such an electrode stack is disadvantageously comparatively time-consuming.

An apparatus is known from WO 2020/212317 A1, which corresponds to US 2022/0216502, which is incorporated herein by reference, and which uses a stacking wheel to produce an electrode stack from monocells.

### SUMMARY OF THE INVENTION

It is therefore an object of the invention to provide a particularly suitable apparatus and a method for producing an electrode stack. In particular, a production of the electrode stack that is as time-saving as possible is to be realized and/or the risk of damage to the electrode stack elements to be stacked is to be reduced.

In an example, the apparatus is used to produce an electrode stack from electrode stack elements. Such an electrode stack element is, for example, an anode, a cathode, a separator, and an anode or cathode laminated with a separator. A composite referred to as a monocell or as a unit cell, which is formed via a (single) anode and a (single) cathode, is preferably referred to as an electrode stack element, wherein a separator (a separator film) is arranged between the anode and the cathode. Furthermore, a further separator is arranged on the side of the cathode facing away from the anode or on the side of the anode facing away from the cathode. Preferably, the anode, the cathode, and the separators are joined together, in particular via lamination. The anodes and cathodes are also collectively referred to as electrodes. These are formed in particular in the shape of a film. The electrodes therefore have a comparatively small dimension in one spatial direction; in other words, the electrodes are formed flat. The electrode stack is preferably provided and designed for a lithium-ion battery cell, in particular for a lithium-ion battery cell of a traction battery for an electrically driven motor vehicle.

The apparatus has a stacking wheel, which has at least one stacking wheel element, in particular at least one stacking wheel disc, which can be rotationally driven (rotationally drivable) about an axis of rotation. The respective stacking wheel element comprises compartments for receiving the electrode stack elements. The compartments are also referred to here and in the following as pockets or receptacles. The respective stacking wheel element has so-called fingers (arms) that extend radially outwards from a central area, wherein in each case a pocket is formed between two fingers (arms). The fingers or compartments are expediently formed curved, in particular spiral-shaped. In a plane perpendicular to the axis of rotation, the compartments therefore have an arcuate, in particular a spiral-shaped, cross section. In other words, the respective compartment runs in an arcuate or spiral shape from its circumferential compartment entrance to its rotational axis-side compartment end. Preferably, a curvature of the arcuate receptacle increases from the circumferential side toward the axis of rotation, therefore, with a decreasing radial distance from the axis of rotation. Because of this, a frictional force between the receptacles and the electrode stack elements, conveyed into them, increases from the circumferential side towards the axis of rotation, therefore, inwards, so that the electrode stack elements are increasingly decelerated. Thus, the electrode stack elements are reliably temporarily decelerated to a standstill relative to the receptacle before the monocells are held by the stripper arm or arms.

The stacking wheel can comprise more than one such stacking wheel element, in particular two, three, four, or five stacking wheel elements. These are arranged spaced apart from each other in an axial direction, therefore, in a direction along the axis of rotation. Expediently, the stacking wheel elements are jointly rotationally drivable using an axis defining the axis of rotation. The stacking wheel elements are preferably aligned with each other in the axial direction. In other words, the stacking wheel elements are of identical design and overlap with regard to the axial direction.

The apparatus can also comprise a stripper for stripping the electrode stack elements from the compartments during a rotation of the stacking wheel. Thus, when the stacking wheel rotates, the electrode stack elements received in the compartments are held against further transport by the stacking wheel and stripped out of the compartment. The stripper therefore forms a type of stop for the electrode stack elements. In this case, the electrode stack elements are stacked on top of each other on a shelf; therefore, they are placed on top of each other to form the electrode stack. The stop surface of the stripper for the electrode stack elements is arranged in the axial direction in front of and/or behind the stacking wheel element and/or, if more than one stacking wheel element is used, between the stacking wheel elements. Preferably, the distance between the stop surface, in particular its edge facing away from the shelf, and the axis of rotation is set (and/or is set during the method for producing the electrode stack) such that it is smaller than the smallest distance between the electrode stack element and the axis of rotation while it is transported in the compartment. Consequently, striking of the stripper by the electrode stack element is prevented and damage to it is avoided. For example, a radial distance of the stripper, in particular its stop surface, to the axis of rotation is smaller than the rotational axis-side compartment end.

Furthermore, the apparatus can also have a conveying device for conveying the electrode stack elements into the compartments of the stacking wheel. On the one hand, the conveying device comprises a transfer device which is used to transfer the electrode stack elements into the compartments. On the other hand, the conveying device comprises a feeding device, which is in particular separate from the transfer device, therefore, structurally separate, and which serves to feed the electrode stack elements to the transfer device. The feeding device is expediently a conveyor belt, for example, a vacuum conveyor belt.

A comparatively precise and defined positioning of the electrode stack elements in the electrode stack is realized particularly advantageously using the device. Furthermore, the electrode stack elements are transferred to the stacking compartment via the stacking wheel without a gripper, therefore, without the use of a gripper or gripping device. Because of this, the alternating stacking of the electrode stack elements advantageously takes place comparatively quickly, therefore, in a time-saving manner, in particular in comparison to the aforementioned production of the electrode stack via a gripping device. Thus, a process rate of the production of the electrode stack is advantageously increased; in other words, throughput is increased.

The transfer time, therefore, the time at which the edge of the respective electrode stack element, which is in front in the transfer direction, can enter the stacking wheel, in particular at which the front edge of the respective electrode stack element first touches the stacking wheel, can be changed via the transfer device, in particular only via the transfer device, and in particular can be adapted to the position of the compartment provided for receiving the respective electrode stack element. Therefore, an adjustment (synchronization) of the transfer time and/or the transfer speed to the rotational speed and/or the (rotational, angular) position of the stacking wheel is enabled in a comparatively easy manner. In particular, if the stacking wheel rotates at a constant rotational speed, this type of adjustment is comparatively efficient using only the transfer device, as the stacking wheel with a comparatively high inertia does not need to be accelerated. In this case, the stacking wheel and/or a drive unit for driving the stacking wheel rotationally expediently comprises a position sensor which can be used to determine the (angular, rotational) position of the stacking wheel or its stacking wheel element or stacking wheel elements and, therefrom, the position of the respective compartment. The apparatus expediently further comprises a sensor, for example, a camera, for detecting the position of the respective electrode stack element in the feeding device, so that the feeding time (transfer time) can be determined on the basis of this position.

Further advantageously, in comparison to conveying the electrode stack elements via a conveyor belt alone, the transfer time of the respective electrode stack element can be changed without also changing the conveying speed of the feeding device (at least temporarily) due to the separate design of the transfer device from the feeding device.

The transfer device can comprise at least two upper transport elements, which are designed as belt bands or as rollers, for example, and which are spaced apart from one another in a direction transverse to the transfer direction, therefore, in the axial direction. When the transport elements are designed as belt bands, the rollers are connected in an expedient manner to a motor via a common first shaft to drive the upper belt bands. Furthermore, the transfer device comprises at least two lower transport elements, which are designed as belt bands or rollers, for example, and which are spaced apart from one another in a direction transverse to the transfer direction, therefore, in the axial direction. When the transport elements are designed as belt bands, the rollers are expediently connected to one another via a common second shaft in order to drive the lower belt bands. In particular, the first and second shafts are coupled to each other via a pair of gears.

For example, the upper transport elements and the lower transport elements are arranged offset to one another in the axial direction; in other words, the upper and lower transport elements are arranged intermeshing one behind the other in the axial direction. Preferably, however, the upper transport elements and the lower transport elements are arranged one above the other in a direction perpendicular to the conveying direction, therefore, to the direction in which the electrode stack elements are conveyed in the transfer device, and/or perpendicular to the axial direction for the clamping conveying of the electrode stack elements. Thus, in this case, one of the upper transport elements is opposite one of the lower transport elements. In other words, a pair of one of the upper and one of the lower transport elements is preferably formed, between which the respective electrode stack element is conveyed in a clamping manner. In other words, they are not offset from each other in the axial direction. In this way, bending of the electrode stack elements by the belt bands is avoided.

For example, the width of the transport elements, therefore, their dimension in the axial direction, is between 1 mm and 250 mm. For example, the upper transport elements each have a width that is different from the width of the lower transport elements. Depending on the design of the electrode stack elements and a suitable clamping force for them, the width of the transport elements and/or their distance from each other is selected accordingly. If the electrode stack elements are designed as monocells, the wider transport elements are provided on the separator side of the monocell, so that the risk of contamination of its electrodes is reduced.

Preferably, each of the transport elements has a width, therefore, a dimension in the axial direction, which is less than a fourth, preferably less than a tenth, of the dimension of the stacking wheel element in the axial direction, or, if a number of stacking wheel elements are used, which is less than a fourth, preferably less than a tenth, of the extent of the distance between the first stacking wheel element in the axial direction and the last stacking wheel element in the axial direction. In this way, the electrode stack elements to be conveyed are only touched by the belt bands on a comparatively small area. Consequently, the risk of damage or contamination of the respective electrode stack element by the transfer device is at least reduced.

The upper transport elements can be sprung against the lower transport elements. In other words, a spring force, therefore, a restoring force, acts on the upper transport elements in the direction of the lower transport elements, therefore, downwards. Additionally or alternatively, the lower transport elements are sprung against the upper transport elements. In other words, a spring force, therefore, a restoring force, acts on the lower transport elements in the direction of the upper transport elements, therefore, upwards. In this way, when the respective electrode stack element is fed into the transfer device, the upper or lower transport elements are adjusted against the spring force. This results in a better clamping of the respective electrode stack element.

For example, the upper transport elements may protrude over the lower transport elements in a direction opposite to the conveying direction. When designed as belt bands, the upper belt bands are longer than the lower belt bands with respect to the conveying direction. In order to feed the respective electrode stack element, the area of the upper belt bands that protrudes over the lower belt bands expediently covers the feeding device designed as a conveyor belt, in particular the transfer device-side end area of the conveyor belt. This end area and the upper belt bands are expediently arranged one above the other, so that the electrode stack elements are fed from the conveyor belt into the transfer device in a clamping manner in this area. Advantageously, a comparatively safe and error-free feed of the respective electrode stack element into the transfer device is realized in this way.

In particular, when the transport elements are designed as belt bands, for example, the axis, closer to the stacking wheel, of the two axes of rotation of the upper transport elements can be offset in the conveying direction to the axis, closer to the stacking wheel, of the two axes of rotation of the lower transport elements. In this way, the respective electrode stack element is guided for a longer time using the transport element, offset closer to the stacking wheel.

The transfer device can have a distance from the axis of rotation in the radial direction, therefore, in a direction perpendicular to the axis of rotation, said distance being greater than the radius, in particular greater than the diameter, of the stacking wheel element. The transfer device is therefore arranged completely outside the area covered by the stacking wheel in the axial direction. In other words, the transfer device is spaced apart from the stacking wheel in the radial direction. Associated therewith, the electrode stack elements are also conveyed into the stacking wheel from outside the area covered by the stacking wheel in the axial direction. When the electrode stack element slides along the inside of the compartment during the transfer, a change in its direction of movement occurs. When the transfer device is arranged spaced apart from the stacking wheel, a space is formed between them into which the electrode stack element rear end, with respect to the conveying direction, can move when the direction changes, so that bending of the electrode stack element due to the change in its direction of movement is advantageously avoided and the risk of damage is reduced as a result. Preferably, the transport elements lie opposite the stacking wheel elements in a direction perpendicular to the axial direction; in other words, the transport elements are not arranged offset from the stacking wheel elements in the axial direction. In this way, only that area of the electrode stack elements is in contact with the stacking wheel or its stacking wheel elements on which the transport elements also act on the respective electrode stack element. An area of force application to the respective electrode stack element is thus reduced.

The transfer device can have a distance from the axis of rotation in the radial direction, therefore, in a direction perpendicular to the axis of rotation, said distance being smaller than the radius of the stacking wheel element. In this case, the transport elements protrude between the stacking wheel elements. In other words, the transport elements are then arranged between the stacking wheel elements in the axial direction, at least in some areas. In particular, the transport elements and the stacking wheel elements are arranged intermeshing with respect to the axial direction. In this way, the installation space for the apparatus is advantageously smaller.

The distance between the stripper, in particular its stop surface, and the axis of rotation can be adjusted. Alternatively or preferably additionally, an inclination of the stripper, in particular its stop surface, can be adjusted.

Preferably, the stop surface of the stripper may always be perpendicular or substantially perpendicular to the support surface of the shelf. In this way, the position of the stripper relative to the compartments can be set and/or readjusted. In particular, the stripper is arranged in such a way that the electrode stack elements strike the stripper essentially vertically, so that pinching and thus damage to the electrode stack elements in the course of stripping is avoided or the risk thereof is at least reduced.

A further aspect of the invention relates to a method for producing an electrode stack from electrode stack elements. For this purpose, an apparatus in one of the variants shown above is used; therefore, such an apparatus is provided in accordance with the method.

According to the method, the electrode stack elements can be fed to the transfer device via the feeding device and transferred to the stacking wheel via the transfer device, therefore, conveyed into the compartments of the stacking wheel element or stacking wheel elements. Expediently, only one electrode stack element is transferred to each compartment.

The electrode stack elements picked up in the compartments can then be conveyed to a shelf by the rotation of the stacking wheel. Therefore, the electrode stack elements are moved towards the shelf guided via the stacking wheel.

The electrode stack elements are then held in the area of the shelf via the stripper. Due to the rotation of the stacking wheel, the electrode stack elements are guided out of the respective receptacle and to the shelf. In other words, the electrode stack elements are held (supported) against the rotation of the stacking wheel via the stripper, so that the respective compartment is moved relative to the respective electrode stack element due to the rotation of the stacking wheel and the electrode stack element is transferred accordingly from the respective compartment to the shelf. In this regard, the electrode stack elements are stacked on top of each other on the shelf to form the electrode stack.

Preferably, the stacking wheel may rotate at a constant rotational speed.

According to an example of the method, as already described in connection with the device, in particular only the conveying speed of the electrode stack elements in the transfer device is changed to adapt the transfer time to a position of the stacking wheel. In this case, the stacking wheel is preferably driven at a constant rotational speed. Therefore, based on the transfer device, in particular solely based on the transfer direction, the transfer time of the respective electrode stack element is adapted to a (rotational, angular) position of the stacking wheel, in particular to the position of the respective compartment for receiving this electrode stack element. If necessary, the transfer time is changed for this purpose; in particular the transfer time is delayed or brought forward compared to a transfer process in which the respective electrode stack element is conveyed at a constant speed in the transfer device (transfer apparatus). For this purpose, the respective electrode stack element is temporarily decelerated or accelerated in the transfer device. The intermittent acceleration or intermittent deceleration is expediently carried out in such a way that the respective electrode stack element has a predetermined transfer speed when exiting the transfer device. In particular, the running speed of the upper and lower belt bands is changed accordingly to adapt the transfer time.

Such electrode stack elements can be used that have a rectangular base with different edge lengths, which therefore do not have a square base. If the electrode stack element has at least one electrode, an electrical contact of the respective electrode, also known as a tab or contact lug, expediently protrudes laterally beyond the base surface. These contacts expediently protrude beyond the base surface on one or both short edges of the respective electrode stack element. Preferably, in this case, the length of the longer edge is between 1.5 and 10 times, in particular between 2 and 5 times, the length of the short edge.

The electrode stack elements can be transferred into the compartments with their longer edge in front, therefore, with one of the two sides forming the longer side. In other words, the two longer edges extend transversely to the transfer direction and the two shorter edges extend parallel to the transfer direction. In this way, the force exerted on the electrode stack element is distributed over a comparatively large area of the electrode stack element when it strikes the stripper and/or the rotation axis-side compartment end, so that the risk of damage is reduced. On the other hand, compared to transferring with the short edge in front, the speed of the stacking wheel is reduced, which is particularly advantageous for a given stacking rate. Consequently, this also enables the braking of the electrode stack element to be carried out particularly gently in the compartments.

At most, a single electrode stack element, therefore, one or none, can be conveyed at any one time via the transfer device. In other words, the electrode stack elements are fed to the transfer device at time intervals in such a way that at most a single electrode stack element is always present in the transfer device for transfer and/or is conveyed using the upper belts. In this way, the transfer time of an electrode stack element can be adjusted without affecting the transfer time of the subsequently fed electrode stack element.

Preferably, in a space-saving manner, the length of the transfer device, in particular its upper belt bands, with respect to the transfer direction, is smaller than the radius of the stacking wheel element or stacking wheel elements and/or smaller than twice the edge length of the short edge of the electrode stack elements.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows in a side view an apparatus for producing an electrode stack from electrode stack elements, wherein the apparatus has a stacking wheel with stacking wheel elements, designed as stacking wheel discs, and a conveying device with a transfer device, via which the electrode stack elements can be transferred into compartments of the stacking wheel discs;

FIG. 2 shows schematically and in part the apparatus in a perspective view;

FIGS. 3a and 3b schematically show in a perspective exploded view or side view an electrode stack element, formed as a monocell, with a rectangular base; and

FIG. 4 shows via a flowchart a process sequence for producing an electrode stack using the apparatus.

### DETAILED DESCRIPTION

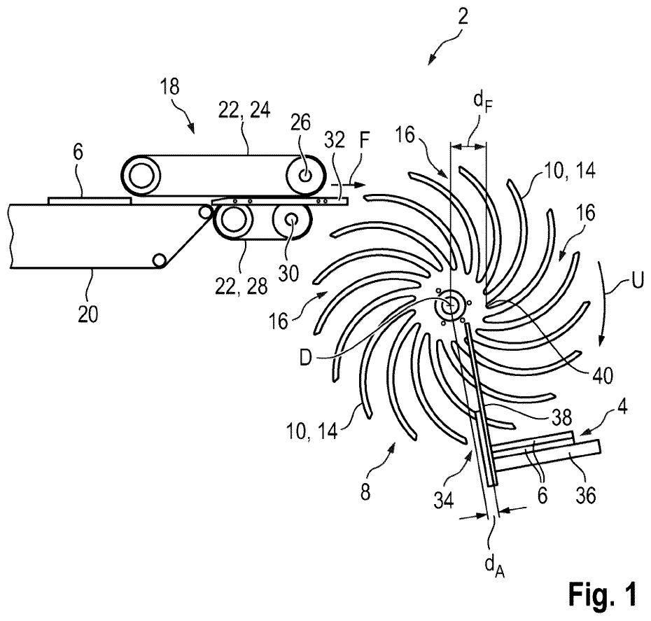

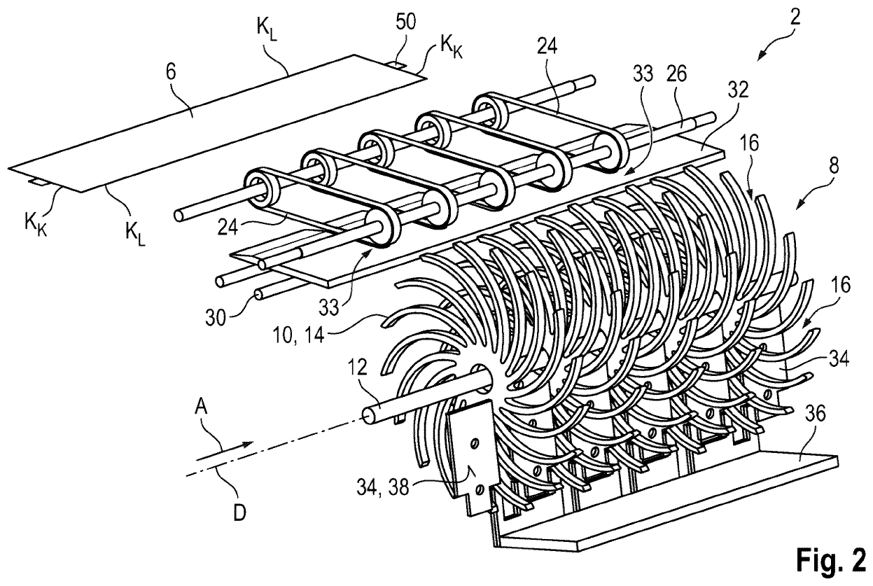

An apparatus 2 for producing an electrode stack 4 from electrode stack elements 6 is shown schematically in a side view in FIG. 1 and in a perspective view FIG. 2. Apparatus 2 comprises a stacking wheel 8, which in turn has at least one stacking wheel element 10, according to the exemplary embodiment shown here five stacking wheel elements 10. According to the exemplary embodiment shown here, stacking wheel elements 10 are designed as stacking wheel discs 10. These can be rotationally driven via a common drive shaft 12. The direction of rotation of stacking wheel 8 is marked with the reference character “U” in FIG. 1. Drive shaft 12 thus defines the axis of rotation D of stacking wheel discs 10. Each stacking wheel disc 10 comprises a plurality of fingers 14, which extend outwards from a central area in a curved manner, in particular in a spiral manner from said area. A compartment 16 is thus formed between two of the fingers 14, which compartment serves to receive one of the electrode stack elements 6. Compartments 16 are arranged one behind the other with respect to the direction of rotation U.

Stacked wheel discs 10 are constructed uniformly to one another and are arranged in alignment along the axis of rotation D in the direction referred to as the axial direction A. Compartments 16 of stacking wheel discs 10 are therefore arranged one behind the other in the axial direction A, therefore, in alignment with each other.

Apparatus 2 further comprises a conveying device 18, via which the electrode stack elements are conveyed, namely, transferred to stacking wheel 8, namely, into compartments 16 of the stacking wheel discs. For this purpose, conveying device 18 is designed in two parts. Conveying device 18 comprises a feeding device 20 in the form of a conveyor belt, via which electrode stack elements 6 are fed to a transfer device 22. Feeding device 20 is not shown further in FIG. 2 for the sake of clarity. Transfer device 22 serves to convey, namely, to transfer, electrode stack elements 6 into compartments 16 of stacking wheel 10. The transfer direction, therefore, the direction which the electrode stack elements have when leaving transfer device 22, is marked with the reference character “F” in FIG. 1.

Transfer device 22 comprises at least two, according to the exemplary embodiment shown here five, upper transport elements, which according to the exemplary embodiment shown here are designed as belt bands 24, which can be driven via a common first drive shaft 26. In this case, upper belt bands 24 are arranged spaced apart from one another in the axial direction A, therefore, transverse to the transfer direction F, in particular equidistantly. Transfer device 22 further comprises at least two, in this case five, lower transport elements which, according to the exemplary embodiment shown here, are also designed as belt bands 28. Five pairs are formed here, each formed of an upper and a lower belt band 24, 28. Thus, lower belt bands 28 are arranged spaced apart from one another in the axial direction A, therefore, transverse to the transfer direction F, in particular equidistantly. Lower belt bands 28 are driven via a second drive shaft 30.

Upper belt bands 24 and lower belt bands 28 are arranged one above the other in a direction perpendicular to the transfer direction F and perpendicular to the axial direction A, so that electrode stack elements 6 can be driven in a clamping manner via a common second drive shaft 30, first drive shaft 26 and second drive shaft 30 being expediently coupled to one another in a manner not shown in detail, for example, via a pair of gears. As shown in more detail in connection with FIG. 4, the transfer time t_{A} of the respective electrode stack element 6 can be changed, in particular adjusted, via transfer device 22. The transfer time t_{A} is understood here to be the time at which the respective electrode stack element 6 completely leaves transfer device 22.

Optionally, transfer device 22 comprises a guide element 32, in particular a guide plate for electrode stack elements 6. Guide element 32 has recesses 33 for the lower belt bands. On the one hand, bending of electrode stack elements 6 during transfer is advantageously avoided via the guide element and, on the other hand, guidance for the electrode stack elements 6 is realized.

Transfer device 22 is arranged at a distance from the axis of rotation D in the radial direction, therefore, in a direction perpendicular to the axis of rotation D, such that its distance is greater than the radius of stacking wheel discs 10. In other words, the transfer device, in particular its belt bands 24, 28 and/or its guide element 32, is arranged completely outside the area encompassed by stacking wheel discs 10. In other words, stacking wheel discs 10 do not cover transfer device 22 in the axial direction A.

As can be seen in particular in FIG. 1, upper belt bands 24 protrude beyond lower belt bands 28 in a direction opposite to the transfer direction F (conveying direction F). This area protruding above lower belt bands 28 is formed in a direction perpendicular to the transfer direction and perpendicular to the axial direction A above the end section of feeding device 20, designed as a conveyor belt. In transfer direction F, guide element 32 and second belt bands 28 are arranged next to the feeding device. In this way, electrode stack elements 6 can be securely transferred from feeding device 20 to transfer device 22 (transfer apparatus 22), therefore, fed to it.

According to an example, drive shaft 26 is arranged above drive shaft 30. The two drive shafts 26, 30 are therefore arranged one above the other in a direction perpendicular to the conveying direction F.

Optionally, in particular likewise in the variant not shown further, upper belt bands 24 are sprung against lower belt bands 28. Thus, transfer device 22 is designed in such a way that when upper belt bands 24 move away from lower belt bands 28, a restoring force acts on the upper belt bands in a direction towards lower belt bands 28. Additionally or alternatively, lower belt bands 28 are sprung against upper belt bands 24. Thus, transfer device 22 is designed in such a way that when lower belt bands 28 move away from upper belt bands 24, a restoring force acts on lower belt bands 28 in a direction towards upper belt bands 24.

Device 2 further comprises a stripper 34, which serves to strip electrode stack elements 6, which are received and conveyed in the compartments, from the compartments onto a shelf 36. The shape of stripper 34 is adapted to the shape of compartments 16 in such a way that electrode stack elements 6 are arranged as perpendicularly as possible to stop surface 38 during striking and stripping. In particular, stop surface 38 is made flat. To position stripper 34, in particular its stop surface 38 with respect to the position and/or shape of compartments 16, the distance d_{A} of stripper 34 from the axis of rotation D and/or an inclination of stripper 34, in particular its stop surface 38, can be adjusted.

The distance d_{A} between stripper 34 and the axis of rotation D is smaller here than the distance de between rotation axis-side compartment end 40 and the axis of rotation D.

A flowchart representing a method for producing an electrode stack 4 from electrode stack elements 6 is shown in FIG. 4. Electrode stack elements 6 are formed rectangular and have different edge lengths. The longer edges are labeled KL and the shorter edges are labeled K_{K}.

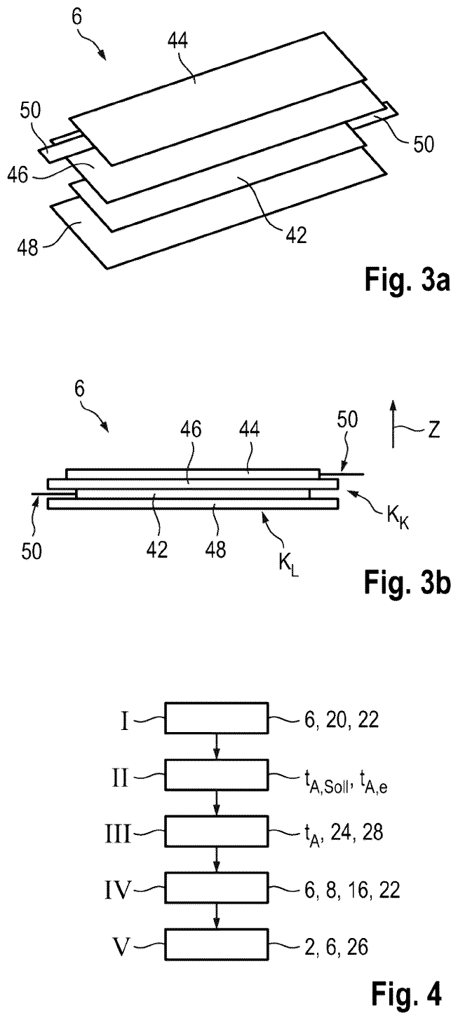

So-called monocells can be used as electrode stack elements 6. These are shown in more detail in FIGS. 3a and 3b. Each monocell is a composite of an anode 42, a cathode 44, a first separator 46 disposed between anode 42 and cathode 44, and a second separator 48 disposed on the side of anode 42 facing away from cathode 44 or first separator 46. In other words, anode 42, cathode 44, and the two separators 46, 48 are arranged one above the other in a monocell vertical direction Z. According to an alternative not shown further, second separator 48 is arranged on that side of cathode 44 which faces away from anode 42 or first separator 46.

The monocells can have a rectangular base area in a plane perpendicular to the monocell vertical direction Z (stacking direction Z). Furthermore, anode 42 and cathode 44 each comprise an electrical contact 50, referred to as a tab, which protrudes beyond the base surface. Separators 46, 48 protrude beyond anode 42 and cathode 44 with the exception of tabs 50. In other words, separators 46, 48 project beyond electrodes 42, 44. When the monocell slides along the inner wall of the respective compartment 16, separator(s) 46, 48 thus touch this inner wall, so that damage to electrodes 42, 44 is avoided.

Preferably, the monocells for a lithium-ion battery cell can be provided and set up for a traction battery of an electrically driven motor vehicle.

The production of electrode stack 4 takes place according to the method using apparatus 2 as shown in FIGS. 1 and 2.

In this case, in a first step I, electrode stack elements 6 are fed to transfer device 22 via feeding device 20. In so doing, the electrode stack elements are preferably fed to transfer device 22 in such a way that at any time at most one of the electrode stack elements is conveyed via transfer device 22, therefore, that only a single (or no) electrode stack element 6 is in contact with the upper and/or lower belt bands 24, 28.

In a second step II, a target transfer time t_{A,Soll} is determined for the respective electrode stack element 6. For this purpose, the current position of compartment 16 into which this electrode stack element 6 is to be transferred, the (preferably constant) rotational speed of stacking wheel discs 10 of stacking wheel 8, as well as the position of the respective electrode stack element 6 on feeding device 20, which is designed as a conveyor belt, and the (preferably constant) conveying speed of feeding device 20 are determined. For this purpose, apparatus 2 comprises, in a manner not shown in detail, a (rotational, angular) position sensor for the stacking wheel and a detection device, for example, comprising a camera, for determining the position of the respective electrode stack element 6 on feeding device 20.

Furthermore, an expected transfer time t_{A,e} is determined for conveying the respective electrode stack element 6 at a constant conveying speed in transfer device 22, therefore, for a constant running speed of the upper and lower belt bands 24, 28.

In step III, the transfer time t_{A} is adjusted to the target transfer time t_{A,Soll} and thus to the position of stacking wheel 8 if the expected transfer time t_{A,e} deviates from the target transfer time t_{A,Soll}. For this purpose, the running speed of the upper and lower belt bands 24, 28 is temporarily increased, which results in an earlier transfer time t_{A}, or temporarily reduced, which results in a delayed transfer time t_{A}. In summary, only the running speed of the belt bands is adjusted. The rotational speed of stacking wheel 8 preferably remains constant.

In step IV, electrode stack elements 6 are transferred to stacking wheel 8 according to the respective target transfer times t_{A,Soll} using transfer device 22. In particular, the respective electrode stack elements are inserted into compartments 16 of all stacking wheel discs 10, said compartments being aligned with one another in the axial direction. The electrode stack elements are expediently transferred to stacking wheel 8 in such a way that only one of the electrode stack elements 6 is transferred to the respective compartment 16 and the next electrode stack element 6 is transferred to the next compartment opposite to the direction of rotation U.

Electrode stack elements 6 are transferred into the respective compartment 16 with their longer edge K_{L} in front.

In step V, electrode stack elements 6 transferred to stacking wheel 8 are carried along due to the rotation of stacking wheel 8 and conveyed to the area of shelf 36. There, electrode stack elements 6 are held by stripper 34 against further transport and are stripped out of the respective compartment 16 due to the rotation of stacking wheel 8. The stripped electrode stack elements 6 are transferred to shelf 36 so that they are deposited on top of each other. In so doing, the side that is on top in transfer device 22 is arranged on top in electrode stack 4 due to the deflection using stacking wheel 8 and vice versa.

In summary, therefore, electrode stack elements 6 are stacked on top of each other using stacking wheel 8 to form electrode stack 4.

The invention is not limited to the exemplary embodiments described above. Rather, other variants of the invention can also be derived herefrom within the scope of the claims by a person skilled in the art, without departing from the subject matter of the invention. In particular, further all individual features described in connection with the exemplary embodiments and/or in the claims can also be combined with one another in other ways, without departing from the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An apparatus for producing an electrode stack from electrode stack elements, the apparatus comprising:
a stacking wheel having at least one stacking wheel element adapted to be rotationally driven about an axis of rotation and having compartments to receive the electrode stack elements;
a stripper to strip the electrode stack elements from the compartments during a rotation of the stacking wheel;
a shelf for the electrode stack elements stripped from the stacking wheel disc; and
a conveyor to convey the electrode stack elements into the compartments, the conveyor comprising a transfer device to transfer the electrode stack elements into the compartments and a feeder to feed the electrode stack elements to the transfer device.

2. The apparatus according to claim 1, wherein the transfer device has a distance from the axis of rotation in a radial direction that is greater than a radius of the stacking wheel disc.

3. The apparatus according to claim 1, wherein the transfer device has at least two upper transport elements spaced apart from one another transverse to a transfer direction, wherein the transfer device has at least two lower transport elements spaced apart from one another transverse to the transfer direction, and/or wherein the upper transport elements and the lower transport elements are arranged one above the other in a direction substantially perpendicular to the conveying direction for a clamping conveying of the electrode stack elements.

4. The apparatus according to claim 3, wherein the at least two upper transport elements are upper belt bands, and wherein the at least two lower transport elements are lower belt bands.

5. The apparatus according to claim 3, wherein the upper transport elements are sprung against the lower transport elements, and/or wherein the lower transport elements are sprung against the upper transport elements.

6. The apparatus according to claim 1, wherein a transfer time of the respective electrode stack element is changeable via the transfer device.

7. The apparatus according to claim 1, wherein a distance between the stripper and the axis of rotation and/or an inclination of its stop surface for the electrode stack elements is adjustable.

8. A method for producing an electrode stack from electrode stack elements, the method comprising:
providing the apparatus according to claim 1;
transferring the electrode stack elements to the stacking wheel via the transfer device; and
stacking the electrode stack elements on top of each other using the stacking wheel.

9. The method according to claim 8, wherein, in order to adapt the transfer time to a position of the stacking wheel, only the conveying speed of the electrode stack elements in the transfer device is changed, and/or wherein the stacking wheel is driven at a constant rotational speed.

10. The method according to claim 8, wherein the electrode stack elements have a rectangular base surface with different edge lengths, and/or wherein the electrode stack elements are transferred into the compartments with their longer edge in front.

11. The method according to claim 8, wherein at most a single electrode stack element is conveyed by the transfer device at any one time.
